(19) United States
(12) Patent Application Publication
(10) Pub. No.: US 2007/0008294 A1
(43) Pub. Date: Jan. 11, 2007

(54) Cordless electromagnetic induction system and method for reminding battery capacity

(76) Inventors: Chia-Te Huang, Zhonghe City (TW); Chih-An Chen, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/174,639

(22) Filed: Jul. 6, 2005

(51) Int. Cl. G09G 5/00

(52) U.S. Cl. 345/173

(57) ABSTRACT

The present invention discloses a cordless electromagnetic induction system, which comprises a cordless pen and a tablet, connecting to a host. In this regards, the cordless pen comprises a battery for supplying power to the pen, a RF (radio frequency)oscillator circuit for generating radio frequency signal, representing the location and status of the pen at a central frequency, and a battery voltage detection apparatus for detecting the output voltage of the battery. The battery voltage detection apparatus commands the RF oscillator circuit for generating a signal, which central frequency is at a warning frequency, while the output voltage of the battery is lower than a critical value. The tablet comprises a tablet RF receiver for receiving RF signal from the RF oscillator circuit. The tablet informed the host for raising a low battery power warning to user while the tablet RF receiver received a signal, which central frequency is at the warning frequency.

### BACKGROUND OF THE INVENTION

1. Field of the Invention

The present invention generally relates to cordless electromagnetic induction system, and more particularly to cordless electromagnetic induction system and method for reminding battery capacity.

2. Description of the Prior Art

Hand-writing recognition apparatus performs as well as computer mouse. Since it is more suitable for drawing and graphics operations than mouse, the development and improvement of hand-writing recognition apparatus is harvest in recent years. The earliest concept of hand-writing recognition apparatus is to replace mouse by pen. For the convenience, a cordless pen and a corresponding tablet is taken place of mouse. Therefore the left button of mouse is usually replaced by the tip of the cordless pen. Although this product is on the shelf for a few years, the normal applications of this kind of product are restricted in graphics and writing input.

Current hand-writing input product is usually a cordless electromagnetic induction system, which comprises a cordless pen with a battery and a tablet. Moreover, the cordless pen comprises an oscillation circuit composed by capacitor. Whenever the tip is touched or pressed, the capacitance would be changed accordingly. Hence the variation of oscillation frequency of the oscillation circuit is also changed in proportional to the difference of the capacitance. Therefore the pressure on the tip could be induced from the variation of oscillation frequency. Furthermore, there may be at least one button on the side of the cordless pen. By the way, the capacitance of the oscillation circuit is also changed according to the status of the button. Therefore the press of the button could be induced from the variation of oscillation frequency. In the other hands, the tablet comprises several components such as detectors, amplifiers, and ADC (analog to digital converter). The central working area of the tablet is the sensor circuit, which comprises arrayed receiving antenna in double sides. The main purpose of the receiving antenna is to receive RF (radio frequency) signal of the corresponding cordless pen, merely. Whenever the pen radiated some RF signal, it would be picked up by the receiving antenna and be translated into some useful information by the tablet.

No matter the battery of the cordless pen is rechargeable or not, the battery power is limited. In the conventional system, users cannot know how much battery power remained. Usually after checking the whole system, user finally finds out that the conventional system is out of battery, not mal-functioned. It not only wastes the check time, but also enhances the un-reliability belief on this system. Moreover, user may not replace or re-charge battery immediately to use the system. Summarized, there exists a need for a cordless electromagnetic system and method for reminding battery capacity to solve these problems.

### SUMMARY OF THE INVENTION

Therefore, in accordance with the previous summary, objects, features and advantages of the present disclosure will become apparent to one skilled in the art from the subsequent description and the appended claims taken in conjunction with the accompanying drawings.

One object of this invention is to disclose a cordless electromagnetic induction system, which comprises a cordless pen and a tablet, connecting to a host. In this regards, the cordless pen comprises a battery for supplying power to the pen, a RF (radio frequency)oscillator circuit for generating radio frequency signal, representing the location and status of the pen at a central frequency, and a battery voltage detection apparatus for detecting the output voltage of the battery. The battery voltage detection apparatus commands the RF oscillator circuit for generating a signal, which central frequency is at a warning frequency, while the output voltage of the battery is lower than a critical value. The tablet comprises a tablet RF receiver for receiving RF signal from the RF oscillator circuit. The tablet informed the host for raising a low battery power warning to user while the tablet RF receiver received a signal, which central frequency is at the warning frequency.

Another object of this invention is to disclose cordless electromagnetic induction system, which comprising a cordless pen, and a tablet, connecting to a host. In this regards, the cordless pen comprising a battery for supplying power to said cordless pen, a RF oscillation and a battery voltage detection apparatus. The RF oscillation circuit is configured to generate RF signal at a central frequency, representing the location and status of said cordless pen, said central frequency could be switched, by said RF oscillation circuit, to one of a plurality of warning frequencies or to a special warning frequency according to what received is one of a plurality of warning signals, corresponding to said plurality of warning frequencies, or a special warning signal, corresponding to said special warning frequency. The battery voltage detection apparatus is configured to detect an output voltage of said battery. A plurality of battery voltage values correspondent to said plurality of warning signals are defined between the maximum voltage of said battery and zero voltage, said special warning signal is sent to said RF oscillation circuit when said output voltage is lower than all of said plurality of battery voltage values for generating RF signal at said special warning frequency as central frequency. One of said plurality of warning signals is sent to said RF oscillation circuit when said output voltage is higher than one of said plurality of battery voltage values, correspondent to said sent warning signal, for generating RF signal at one of said plurality of special warning frequencies, correspondent to said sent warning signal, as central frequency. The tablet comprising a tablet RF receiver for receiving RF signal, representing the location and status of said cordless pen, said host was informed by said tablet for issuing a low voltage warning signal, representing said output voltage is higher than said battery voltage value, to user when received RF signal is at said warning frequency, correspondent to said battery voltage value, as central frequency.

Accordingly, the user could know the remained battery power capacity with the help of the system provided by the present invention.

### BRIEF DESCRIPTION OF THE DRAWINGS

The accompanying drawings incorporated in and forming a part of the specification illustrate several aspects of the present invention, and together with the description serve to explain the principles of the disclosure. In the drawings:

FIG. 1 is a block diagram shows a cordless electromagnetic induction system for reminding battery capacity of an embodiment in accordance with the present invention;

FIG. 2A is a flow chart diagram of the cordless pen shown in the FIG. 1;

FIG. 2B is a flow chart diagram of the tablet shown in the FIG. 1;

FIG. 3 is a block diagram shows a cordless electromagnetic induction system for reminding battery capacity of another embodiment in accordance with the present invention;

FIG. 4 is a diagram depicts frequencies and signals applied on the system shown in the FIG. 3;

FIG. 5A is a flow chart diagram of the cordless pen shown in the FIG. 3; and

FIG. 5B is a flow chart diagram of the tablet shown in the FIG. 3.

### DETAILED DESCRIPTION OF THE PREFERRED EMBODIMENTS

The present disclosure can be described by the embodiments given below. It is understood, however, that the embodiments below are not necessarily limitations to the present disclosure, but are used to a typical implementation of the invention.

Having summarized various aspects of the present invention, reference will now be made in detail to the description of the invention as illustrated in the drawings. While the invention will be described in connection with these drawings, there is no intent to limit it to the embodiment or embodiments disclosed therein. On the contrary the intent is to cover all alternatives, modifications and equivalents included within the spirit and scope of the invention as defined by the appended claims.

It is noted that the drawings presents herein have been provided to illustrate certain features and aspects of embodiments of the invention. It will be appreciated from the description provided herein that a variety of alternative embodiments and implementations may be realized, consistent with the scope and spirit of the present invention.

It is also noted that the drawings presents herein are not consistent with the same scale. Some scales of some components are not proportional to the scales of other components in order to provide comprehensive descriptions and emphasizes to this present invention.

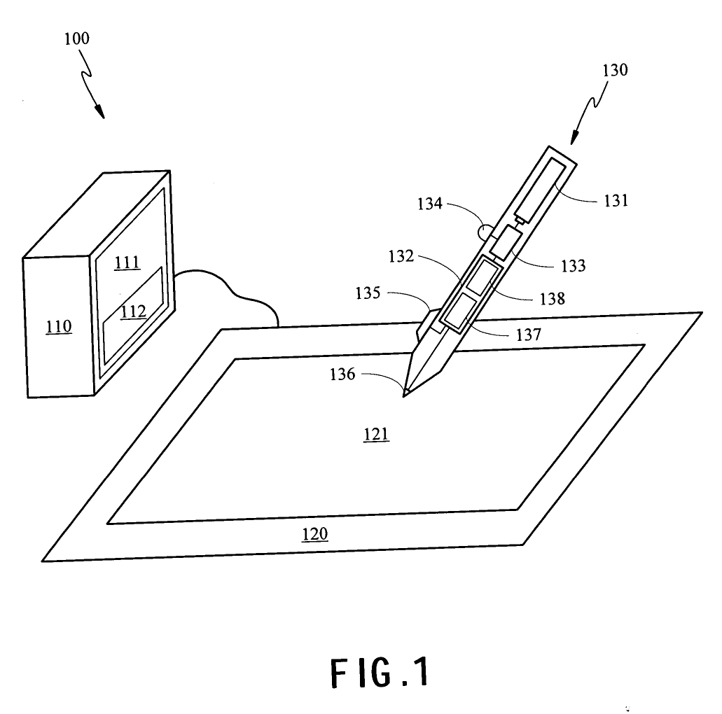

Please refer to FIG. 1, which is a block diagram shows a cordless electromagnetic induction system 100 for reminding battery capacity of an embodiment in accordance with the present invention. The system 100 comprises a cordless pen 130 and a tablet 120, connecting to a host 110. In this regards, the cordless pen 130 further comprises a battery 131 for supplying power to the cordless pen 130, a RF (Radio Frequency) oscillation circuit 132, a battery voltage detection apparatus 133, a battery warning light 134 connecting to the battery voltage detection apparatus 133, at least one button 135, and a tip 136. The button 135 and the tip 136 are connected to the RF oscillation circuit 132. When the button 135 and/or the tip 136 are pressed or touched, the frequency of radio emitted by the RF oscillation circuit 135 would be changed according to the level of pressure. Therefore a tablet RF receiver 121 of the tablet 120 would know the pressure level of the button 135 and/or the tip 136 according to the received radio frequency emitted by the RF oscillation circuit 132. Generally, the host 110 usually comprises an OS (operating system) 111 and a driver 112 for communicating the system 100 and the OS 111.

As shown in the FIG. 1, the battery voltage could be detected by the battery voltage detection apparatus 133, which is connected to the RF oscillation circuit 132. In one example of this embodiment, the maximum output voltage of this battery is 1.5 volt and the radio emitted by the RF oscillation circuit 132 is maintained at a normal frequency, for example, 170 kHz. When the battery power consumed, once the output voltage detected by the battery voltage detection apparatus 133 is under a threshold, a low voltage signal would be sent to the RF oscillation circuit 132. Accordingly, the radio emitted by the RF oscillation circuit 132 would be maintained at another warning frequency, for example, 120 kHz. If the output voltage of the battery 131 is remained above the threshold, a normal voltage signal would be sent to the RF oscillation circuit 132 from the battery voltage detection apparatus 133. Therefore the radio emitted by the RF oscillation circuit 132 is still maintained at the normal frequency. Once the central frequency, received by the tablet RF receiver 121, is changed to the warning frequency from the normal frequency, the driver 112 would be informed by the tablet 120. Hence, a low voltage warning signal would be sent to user by the driver 112 through the help of the OS 111. In this regards, the low voltage warning signal could be any audio and/or visual signal, popup window, flash, color change on the screen and/or other forms. The present invention does not restrict the form of the low voltage warning signal.

In one example of the embodiment, the warning frequency is lower than the normal frequency for reducing the power consumption. In another example of the embodiment, the RF oscillation circuit 132 could further comprises a normal oscillation circuit 137 for emitting radio at the normal frequency and a warning oscillation circuit 138 for emitting radio at the warning frequency. In such case, the power consumption of the warning oscillation circuit 138 is lower than the power consumption of the normal oscillation circuit 137. In another example of the embodiment, the battery warning light 134 would be turned on when the voltage detected by the battery voltage apparatus 133 is lower than the threshold.

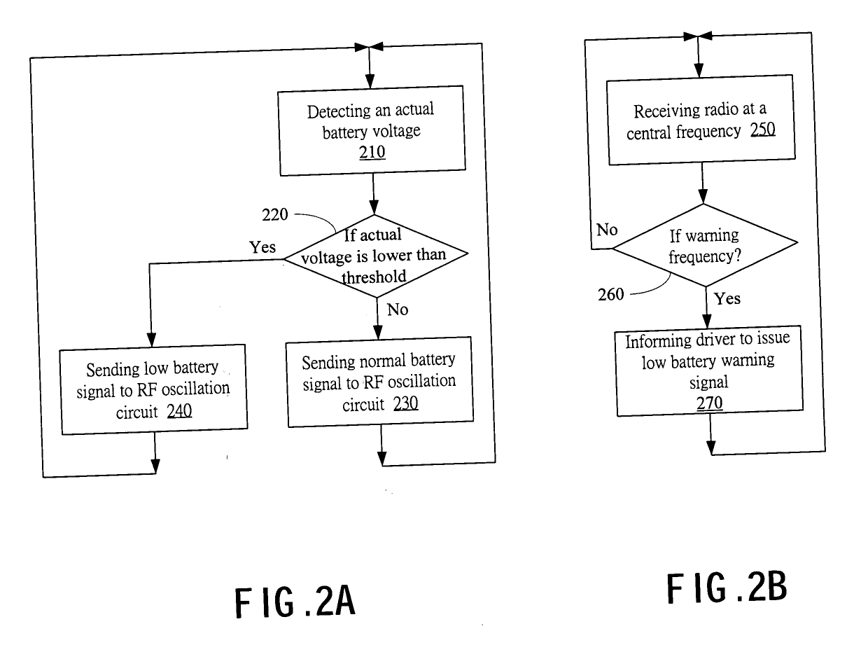

Please refer to the FIG. 2A, which is a flow chart diagram of the cordless pen 130 shown in the FIG. 1. In a step 210, the output voltage of the battery 131 is detected by the battery voltage detection apparatus 133. Next, the detected voltage is compared with the threshold by the battery voltage detection apparatus 133 in a step 220. If the output voltage is higher than the threshold, the normal voltage signal would be sent to the RF oscillation circuit 132 by the battery voltage detection apparatus 133 in a step 230; otherwise, the warning voltage signal would be sent to the RF oscillation circuit 132 by the battery voltage detection apparatus 133 and/or the battery warning light 134 would be turned on in a step 240. Finally, the flow chart returns to the step 210 and repeats itself continuously.

Please refer to the FIG. 2B, which is a flow chart diagram of the tablet 120 shown in the FIG. 1. A central frequency of radio is received by the tablet RF receiver 121 in a step 250. Next, the received central frequency is compared with the warning frequency in a step 260. If the received central frequency is equal to the warning frequency, the driver 112 is informed by the tablet 120. The low voltage warning signal would be issued via the OS 111. Finally, the flow chart returns to the step 250 and repeats itself continuously.

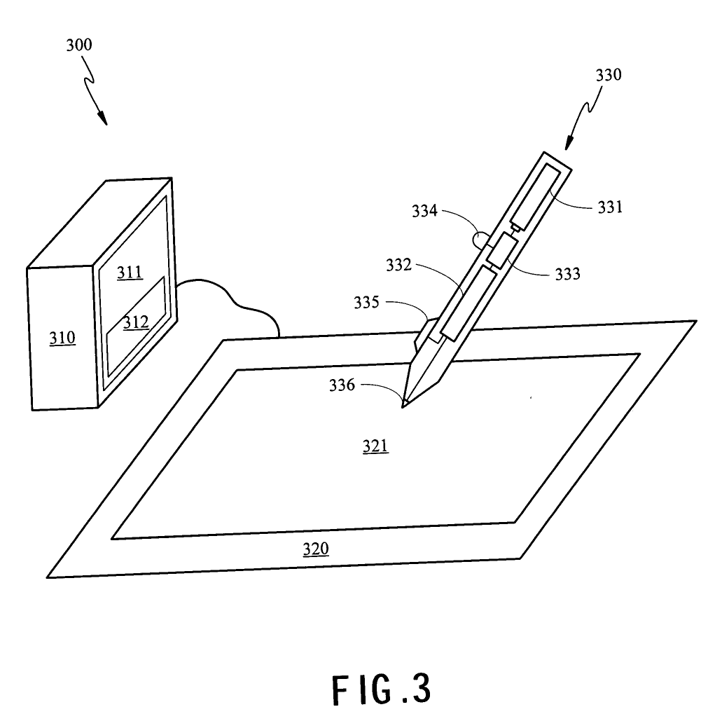

Please refer to FIG. 3, which is a block diagram shows a cordless electromagnetic induction system 300 for reminding battery capacity of another embodiment in accordance with the present invention. The system 300 comprises a cordless pen 330 and a tablet 320, connecting to a host 310. In this regards, the cordless pen 330 further comprises a battery 331 for supplying power to the cordless pen 330, a RF (Radio Frequency) oscillation circuit 332, a battery voltage detection apparatus 333, a battery warning light 334 connecting to the battery voltage detection apparatus 333, at least one button 335, and a tip 336. The button 335 and the tip 336 are connected to the RF oscillation circuit 332. When the button 335 and/or the tip 336 are pressed or touched, the frequency of radio emitted by the RF oscillation circuit 335 would be changed according to the level of pressure. Therefore a tablet RF receiver 321 of the tablet 320 would know the pressure level of the button 335 and/or the tip 336 according to the received radio frequency emitted by the RF oscillation circuit 332. Generally, the host 310 usually comprises an OS (operating system) 311 and a driver 312 for communicating the system 300 and the OS 311.

As shown in the FIG. 3, the battery voltage could be detected by the battery voltage detection apparatus 333, which is connected to the RF oscillation circuit 332. In one example of this embodiment, the maximum output voltage of this battery is 1.5 volt and the radio emitted by the RF oscillation circuit 332 is maintained at a normal frequency, for example, 370 kHz.

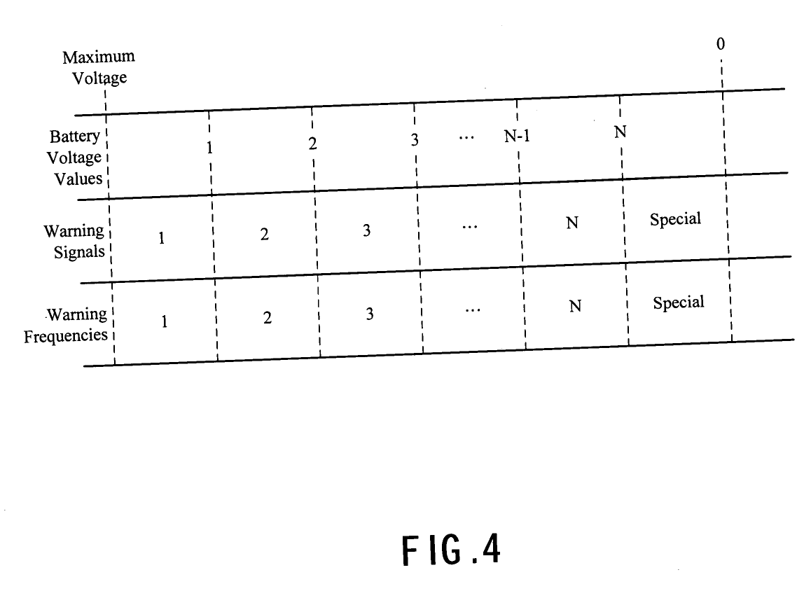

Please refer to the FIG. 4, which is a diagram depicts frequencies and signals applied on the system shown in the FIG. 3. The radio emitted by the RF oscillation circuit 332 could be switched at a plurality of central frequencies; each frequency is corresponding to a plurality of battery voltage values and a plurality of warning signals received by the RF oscillation circuit 332. It is said that the plurality of battery voltage values, which are all lower than the maximum output voltage, are also corresponding to the plurality of warning signals. For convenience, a decreasing list is formed by the plurality of battery voltage values; in other words, a later voltage value is less than a former voltage value in this decreasing list. In one example of this embodiment, the corresponding pluralities of warning frequencies and signals are also forming decreasing lists. However, the present invention does not restrict that the plurality of warning frequencies and corresponding plurality of battery voltage values are listed in a decreasing order.

When the power of batter 331 consumed, an actual battery voltage detected by the battery voltage detection apparatus 333 is higher than an Nth battery voltage value and lower than a N−1th battery voltage value, a Nth warning signal is issued by the battery voltage detection apparatus 333 to the RF oscillation circuit 332. Subsequently, the radio emitted by the RF oscillation circuit 332 is maintained at an Nth warning frequency as central frequency. However, when the actual battery voltage is still higher than the first battery voltage value, a first warning signal is issued by the battery voltage detection apparatus 333 to the RF oscillation circuit 332. Subsequently, the radio emitted by the RF oscillation circuit 332 is maintained at a first warning frequency as central frequency. Moreover, when the actual battery voltage is lower than the last and the smallest battery voltage value, a special warning signal is issued by the battery voltage detection apparatus 333 to the RF oscillation circuit 332. Subsequently, the radio emitted by the RF oscillation circuit 332 is maintained at a special warning frequency as central frequency.

In one example of the embodiment, the battery warning light 334 has a plurality of warning light signals corresponding to the pluralities of battery voltage values, warning signals, and warning frequencies. When an actual battery voltage detected by the battery voltage detection apparatus 333 is higher than an Nth battery voltage value and lower than a N−1th battery voltage value, the Nth warning light signal are displayed by the battery warning light 334, ordered by the battery voltage detection apparatus 333. In this example, the plurality of warning light signals may be presented by flash frequencies, color changes, or any combinations of flash frequencies and color changes. The present invention does not restrict the representation formats of the plurality of warning light signals displayed the battery warning light 334.

After receiving by the tablet RF receiver 321, the tablet 320 determined that which one of the plurality of warning frequencies or the special warning frequency is equals to the central frequency of the received radio, and the driver 312 would be informed the result consequently. Therefore, a low voltage warning signal would be showed to user by the driver 312 via the OS 311. In this regards, the low voltage warning signal could be any audio and/or visual signal, popup window, flash, color change on the screen and/or other forms. The present invention does not restrict the form of the low voltage warning signal. Moreover, the low voltage warning signal could be displayed as the plurality of battery voltage values, for example, 1.5 volt, 1.4 volt, and etc.

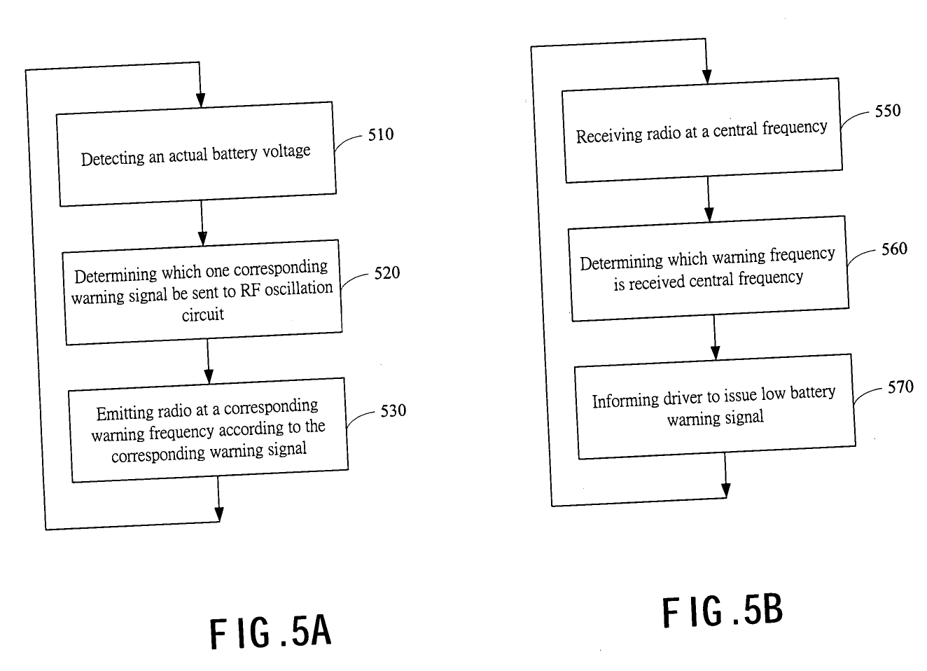

Please refer to the FIG. 5A, which is a flow chart diagram of the cordless pen 330 shown in the FIG. 3. In a step 510, the output voltage of the battery 331 is detected by the battery voltage detection apparatus 333. Next, the battery voltage detection apparatus 333 determines that which one of the plurality of warning signals should be sent to the RF oscillation circuit 332 according to the detected voltage in a step 520. The RF oscillation circuit 332 emits radio in the corresponding warning frequency according to received warning signal in a step 540. Finally, the flow chart returns to the step 510 and repeats itself continuously.

Please refer to the FIG. 5B, which is a flow chart diagram of the tablet 520 shown in the FIG. 3. A central frequency of radio is received by the tablet RF receiver 321 in a step 550. Next, the received central frequency is determined as which one of the plurality of warning frequencies by the tablet 320 in a step 560. In a following step 560, the low voltage warning signal would be presented to user with the help of the OS 311, in consequence of the driver 312 is informed by the tablet 320 with the result of the step 560. Finally, the flow chart returns to the step 550 and repeats itself continuously.

The foregoing description is not intended to be exhaustive or to limit the invention to the precise forms disclosed. Obvious modifications or variations are possible in light of the above teachings. In this regard, the embodiment or embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the inventions as determined by the appended claims when interpreted in accordance with the breath to which they are fairly and legally entitled.

It is understood that several modifications, changes, and substitutions are intended in the foregoing disclosure and in some instances some features of the invention will be employed without a corresponding use of other features. Accordingly, it is appropriate that the appended claims be construed broadly and in a manner consistent with the scope of the invention.

1. A cordless electromagnetic induction system, comprising:
a cordless pen, wherein said cordless pen comprising:
a battery for supplying power to said cordless pen;
a radio frequency (RF) oscillation circuit for generating RF signal representing the location and status of said cordless pen; and
a battery voltage detection apparatus for detecting an output voltage of said battery, said RF oscillation circuit is ordered, by said battery voltage detection apparatus, to generate RF signal at a warning frequency as central frequency when said output voltage is lower than a threshold; and
a tablet, connecting to a host, wherein said tablet comprising a tablet RF receiver for receiving RF signal, representing the location and status of said cordless pen, said host was informed by said tablet for issuing a low voltage warning signal to user when received RF signal is at said warning frequency as central frequency.

2. A cordless electromagnetic induction system of claim 1, wherein said cordless pen further comprising a tip, connecting to said RF oscillation circuit, said RF oscillation circuit generates RF signal representing the status of said tip.

3. A cordless electromagnetic induction system of claim 1, wherein said cordless pen further comprising a button, connecting to said RF oscillation circuit, said RF oscillation circuit generates RF signal representing the status of said button.

4. A cordless electromagnetic induction system of claim 1, wherein said cordless pen further comprising a battery warning light, connecting to said battery voltage detection apparatus, said battery warning light is turned on by said battery voltage detection apparatus to caution user.

5. A cordless electromagnetic induction system of claim 1, wherein said RF oscillation circuit further comprising a normal RF oscillation circuit for generating RF signal at a normal frequency and a warning RF oscillation circuit for generating RF signal at a warning frequency.

6. A cordless electromagnetic induction system of claim 5, wherein said warning RF oscillation circuit consumes less power than said normal RF oscillation circuit.

7. A cordless electromagnetic induction method, comprising:
providing a cordless pen and a tablet, connecting to a host, wherein said cordless pen comprising a battery for supplying power to said cordless pen, a radio frequency (RF) oscillation circuit for generating RF signal representing the location and status of said cordless pen, and a battery voltage detection apparatus for detecting an output voltage of said battery, said tablet comprising a tablet RF receiver for receiving RF signal, representing the location and status of said cordless pen;
generating RF signal at a warning frequency as central frequency, by said RF oscillation circuit following instruction from said battery voltage detection apparatus, when said output voltage is lower than a threshold; and
issuing a low voltage warning signal to user, by said host following instruction from said tablet, when received RF signal is at said warning frequency as central frequency.

8. A cordless electromagnetic induction method of claim 7, wherein said cordless pen further comprising a tip, connecting to said RF oscillation circuit, said RF oscillation circuit generates RF signal representing the status of said tip.

9. A cordless electromagnetic induction method of claim 7, wherein said cordless pen further comprising a button, connecting to said RF oscillation circuit, said RF oscillation circuit generates RF signal representing the status of said button.

10. A cordless electromagnetic induction method of claim 7, wherein said cordless pen further comprising a battery warning light, connecting to said battery voltage detection apparatus, said battery warning light is turned on by said battery voltage detection apparatus to caution user.

11. A cordless electromagnetic induction method of claim 7, wherein said RF oscillation circuit further comprising a normal RF oscillation circuit for generating RF signal at a normal frequency and a warning RF oscillation circuit for generating RF signal at a warning frequency.

12. A cordless electromagnetic induction method of claim 11, wherein said warning RF oscillation circuit consumes less power than said normal RF oscillation circuit.

13. A cordless electromagnetic induction system, comprising:
a cordless pen, wherein said cordless pen comprising:
a battery for supplying power to said cordless pen;
a radio frequency (RF) oscillation circuit for generating RF signal at a central frequency, representing the location and status of said cordless pen, said central frequency could be switched, by said RF oscillation circuit, to one of a plurality of warning frequencies or to a special warning frequency according to what received is one of a plurality of warning signals, corresponding to said plurality of warning frequencies, or a special warning signal, corresponding to said special warning frequency; and
a battery voltage detection apparatus for detecting an output voltage of said battery, a plurality of battery voltage values correspondent to said plurality of warning signals are defined between the maximum voltage of said battery and zero voltage, said special warning signal is sent to said RF oscillation circuit when said output voltage is lower than all of said plurality of battery voltage values for generating RF signal at said special warning frequency as central frequency, one of said plurality of warning signals is sent to said RF oscillation circuit when said output voltage is higher than one of said plurality of battery voltage values, correspondent to said sent warning signal, for generating RF signal at one of said plurality of special warning frequencies, correspondent to said sent warning signal, as central frequency; and
a tablet, connecting to a host, wherein said tablet comprising a tablet RF receiver for receiving RF signal, representing the location and status of said cordless pen, said host was informed by said tablet for issuing a low voltage warning signal, representing said output voltage is higher than said battery voltage value, to user when received RF signal is at said warning frequency, correspondent to said battery voltage value, as central frequency.

14. A cordless electromagnetic induction system of claim 13, wherein said cordless pen further comprising a tip, connecting to said RF oscillation circuit, said RF oscillation circuit generates RF signal representing the status of said tip.

15. A cordless electromagnetic induction system of claim 13, wherein said cordless pen further comprising a button, connecting to said RF oscillation circuit, said RF oscillation circuit generates RF signal representing the status of said button.

16. A cordless electromagnetic induction system of claim 13, wherein said cordless pen further comprising a battery warning light, connecting to said battery voltage detection apparatus, a plurality of warning light signals, corresponding to said plurality of battery voltage values, could be displayed by said battery warning light, one of said plurality of warning light signals is displayed by said battery warning light according to said output voltage.

17. A cordless electromagnetic induction system of claim 13, wherein said low voltage warning signal is displayed as said plurality of battery voltage values.

18. A cordless electromagnetic induction method, comprising:
providing a cordless pen and a tablet, connecting to a host, wherein said cordless pen comprising a battery for supplying power to said cordless pen, a radio frequency (RF) oscillation circuit for generating RF signal at a central frequency, representing the location and status of said cordless pen, and a battery voltage detection apparatus for detecting an output voltage of said battery, wherein said central frequency could be switched, by said RF oscillation circuit, to one of a plurality of warning frequencies or to a special warning frequency according to what received is one of a plurality of warning signals, corresponding to said plurality of warning frequencies, or a special warning signal, corresponding to said special warning frequency, a plurality of battery voltage values correspondent to said plurality of warning signals are defined between the maximum voltage of said battery and zero voltage, said tablet comprising a tablet RF receiver for receiving RF signal, representing the location and status of said cordless pen;
generating RF signal at said special warning frequency as central frequency, after said RF oscillation circuit receiving said special warning signal when said output voltage is lower than all of said plurality of battery voltage values, generating RF signal at one of said plurality of special warning frequencies, correspondent to said sent warning signal, as central frequency, after said RF oscillation circuit receiving one of said plurality of warning signals when said output voltage is higher than one of said plurality of battery voltage values, correspondent to said sent warning signal; and
issuing a low voltage warning signal, representing said output voltage is higher than said battery voltage value, to user, by said host following instruction from said tablet, when received RF signal is at said warning frequency, correspondent to said battery voltage value, as central frequency.

19. A cordless electromagnetic induction method of claim 18, wherein said cordless pen further comprising a tip, connecting to said RF oscillation circuit, said RF oscillation circuit generates RF signal representing the status of said tip.

20. A cordless electromagnetic induction method of claim 18, wherein said cordless pen further comprising a button, connecting to said RF oscillation circuit, said RF oscillation circuit generates RF signal representing the status of said button.

21. A cordless electromagnetic induction method of claim 18, wherein said cordless pen further comprising a battery warning light, connecting to said battery voltage detection apparatus, a plurality of warning light signals, corresponding to said plurality of battery voltage values, could be displayed by said battery warning light, one of said plurality of warning light signals is displayed by said battery warning light according to said output voltage.

22. A cordless electromagnetic induction method of claim 18, wherein said low voltage warning signal is displayed as said plurality of battery voltage values.
